(19) United States
(12) Patent Application Publication
(10) Pub. No.: US 2013/0152024 A1
(43) Pub. Date: Jun. 13, 2013

(54) ELECTRONIC DEVICE AND PAGE ZOOMING METHOD THEREOF

(71) Applicants: HAI-SEN LIANG, Shenzhen City (CN); CHIH-SAN CHIANG, Tu-Cheng (TW); HUA-DONG CHENG, Shenzhen City (CN); HAN-CHE WANG, Tu-Cheng (TW); HAI-JUN MAO, Shenzhen City (CN); TE-JIA LIU, Shenzhen City (CN)

(72) Inventors: HAI-SEN LIANG, Shenzhen City (CN); CHIH-SAN CHIANG, Tu-Cheng (TW); HUA-DONG CHENG, Shenzhen City (CN); HAN-CHE WANG, Tu-Cheng (TW); HAI-JUN MAO, Shenzhen City (CN); TE-JIA LIU, Shenzhen City (CN)

(21) Appl. No.: 13/659,853

(22) Filed: Oct. 24, 2012

(30) Foreign Application Priority Data
Dec. 13, 2011 (CN) 201110414192.7

(51) Int. Cl. G06F 3/033

(52) U.S. Cl. 715/863

(57) ABSTRACT

A page zooming method for an electronic device having a touch screen and a storage unit is provided. The method includes the following steps: generating operation signals in response to a touch operation applied on a page displayed on the touch screen; determining the touch operation being a zooming gesture if the touch operation comprising a press operation and a slide operation at a same time; determining the slide direction and determining the type of the zooming gesture according to the determined slide direction of the slide operation, the type of the zooming gesture comprising a zooming in gesture and a zooming out gesture; creating a zoomed page of the page displayed on the touch screen according to the type of the zooming gesture; and displaying the zoomed page on the touch screen. An electronic device using the page zooming method is also provided.

### BACKGROUND

1. Technical Field

The present disclosure relates to an electronic device and a page zooming method for the electronic device.

2. Description of Related Art

Nowadays, electronic devices with touch screens, e.g., mobile phones, digital photo frames, electronic readers (e-reader), are capable of zooming the page displayed on the touch screen by manipulating the touch screen. For example, for zooming out the displayed page, the user uses two fingers sliding towards each other, and for zooming in the displayed page, the user uses two fingers sliding away from each other. However, both two fingers slide for applying the zooming method, which can not satisfy various demands of different users.

Therefore, what is needed is an electronic device and a page zooming method thereof to alleviate the limitations described above.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding sections throughout the several views.

FIG. 1 is a block diagram of an electronic device in accordance with an exemplary embodiment.

FIG. 2 is a schematic diagram of the electronic device of FIG. 1.

FIGS. 3a-3d are schematic diagrams showing the zooming effect of the electronic device of FIG. 1, in accordance with an exemplary embodiment.

FIGS. 4a-4d are schematic diagrams showing the zooming effect of the electronic device of FIG. 1, in accordance with another exemplary embodiment.

FIG. 5 is a flowchart of a page zooming method for electronic devices, such as the one of FIG. 1, in accordance with the exemplary embodiments.

### DETAILED DESCRIPTION

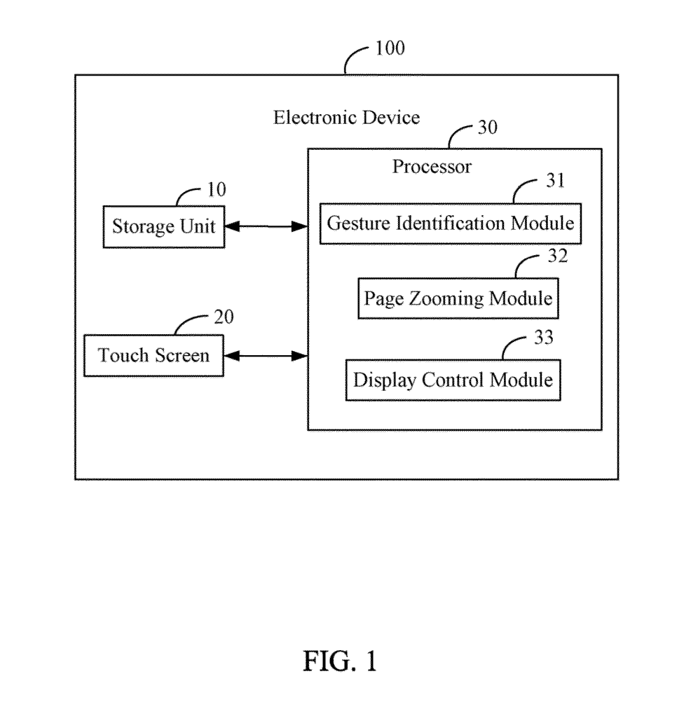

FIG. 1 is an exemplary embodiment of a disclosure of an electronic device 100. The electronic device 100 can conveniently zoom the displayed contents in response to a touch operation. The electronic device 100 is a mobile terminal with a touch screen, such as a mobile phone. In alternative embodiments, the electronic device 100 can be other electronic devices with touch screens, such as an electronic reader, a tablet, a digital phone frame or the like.

The electronic device 100 includes a storage unit 10, a touch screen 20, and a processor 30. The storage unit 10 stores a plurality of electronic files. The electronic file includes pictures, and/or photos etc. The touch screen 20 is configured for generating corresponding operation signals in response to a user's touch operation. For example, the user can operate the touch screen to open an electronic file, flip pages, zooming a displayed page in or out, select a page, or drag a page for example.

The processor 30 includes a gesture identification module 31, a page zooming module 32, and a display control module 33.

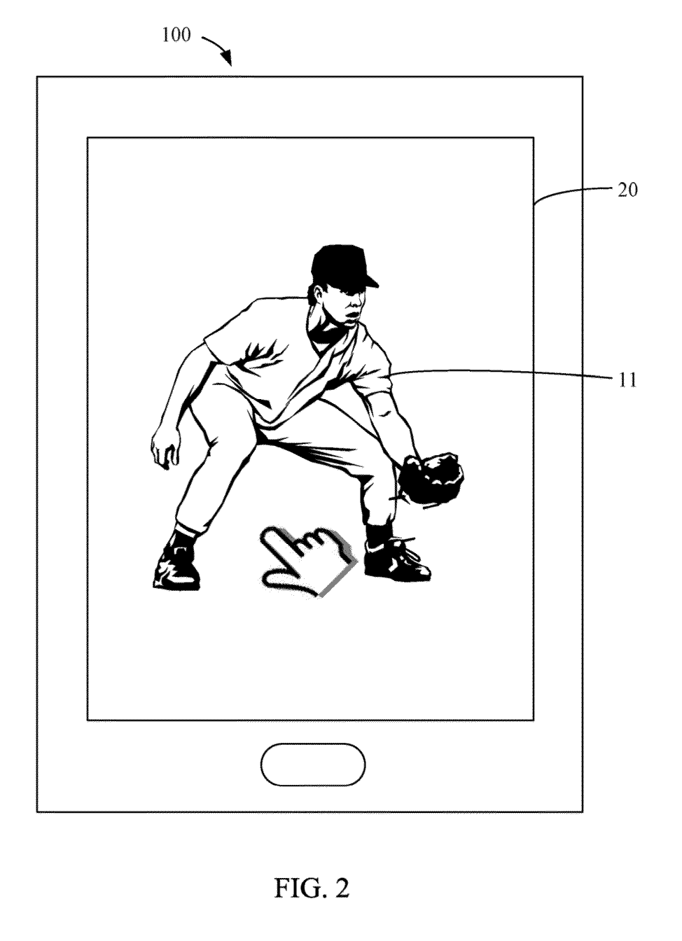

In the embodiment, when the electronic device 100 is activated, the touch screen 20 displays a default icon interface or a page of an electronic device selected by a user. FIG. 2 shows a page 11 is displayed on the touch screen 20. The page 11 includes a picture. In an alternative embodiment, the displayed page can also include characters and/or figures, for example. If a zooming gesture is applied on the page 11, the page 11 will be zoomed accordingly.

The gesture identification module 31 is configured for identifying the touch operation according to the operation signals generated by the touch screen 20 in response to a touch operation. The gesture identification module 31 is also configured for determining whether the identified touch operation is a zooming gesture, and transmitting the identifying and determining results to the page zooming module 32. In this embodiment, when the gesture identification module 31 identifies the touch operation comprises a press operation and an immediately subsequent slide operation applied on the touch screen 20, the gesture identification module 31 determines the identified touch operation is a zooming gesture. The gesture identification module 31 continues to determine the slide direction of the slide operation so as to determine the type of the zooming gesture according to the determined slide direction of the slide operation. The type of the zooming gestures includes the zooming in gesture and the zooming out gesture.

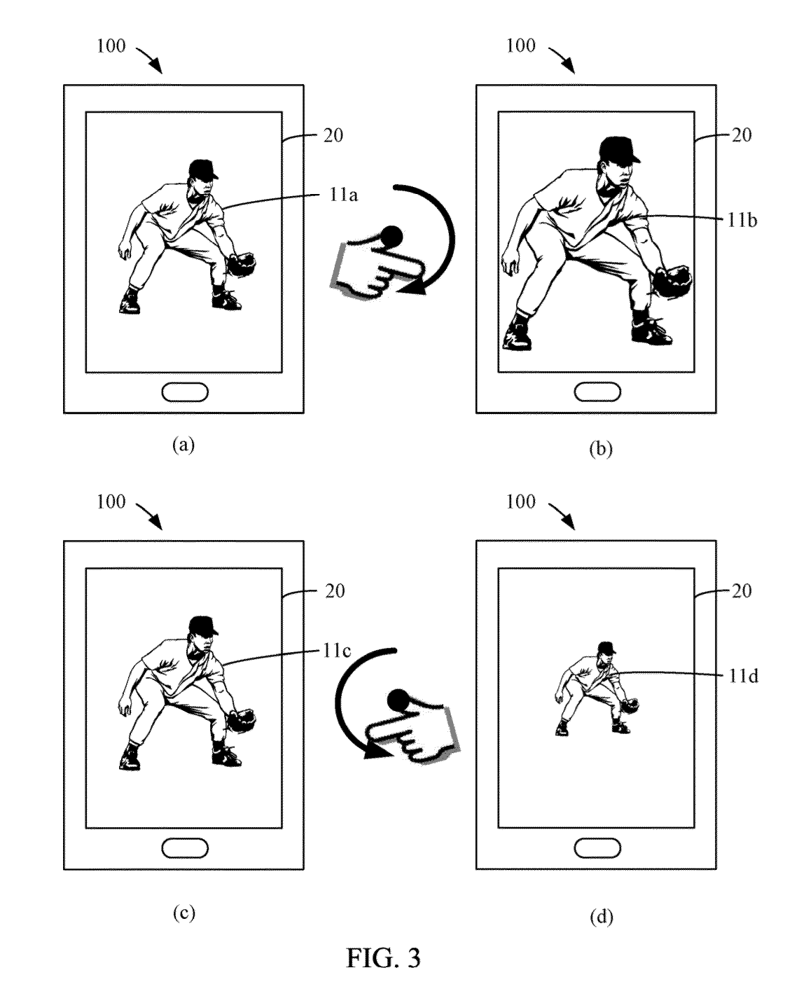

In a first embodiment, when the gesture identification module 31 identifies that one finger of the user creates a touch point on the touch screen 20, another finger slides clockwise on the touch screen 20, the gesture identification module 31 determines the touch operation is a zooming in gesture. When the gesture identification module 31 identifies that one finger of the user creates a touch point on the touch screen 20, another finger slides counterclockwise on the touch screen 20, the gesture identification module 31 determines the touch operation is a zooming out gesture. The details will be illustrated with reference to FIG. 3 later.

In a second embodiment, when the gesture identification module 31 identifies that one finger of the user creates a touch point on the touch screen 20, another finger slides clockwise on the touch screen 20, the gesture identification module 31 determines the touch operation is a zooming out gesture. When the gesture identification module 31 identifies that one finger of the user creates a touch point on the touch screen 20, another finger slides counterclockwise on the touch screen 20, the gesture identification module 31 determines the touch operation is a zooming in gesture. In an alternative embodiment, the slide operation can be other slide touch operation, such as sliding horizontally leftward, sliding horizontally rightward, sliding vertically upward, sliding vertically downward, sliding away from the touch point, or sliding towards the touch point, for example. The slide operations having opposite slide directions are determined to be the zooming in operation or the zooming out operation respectively.

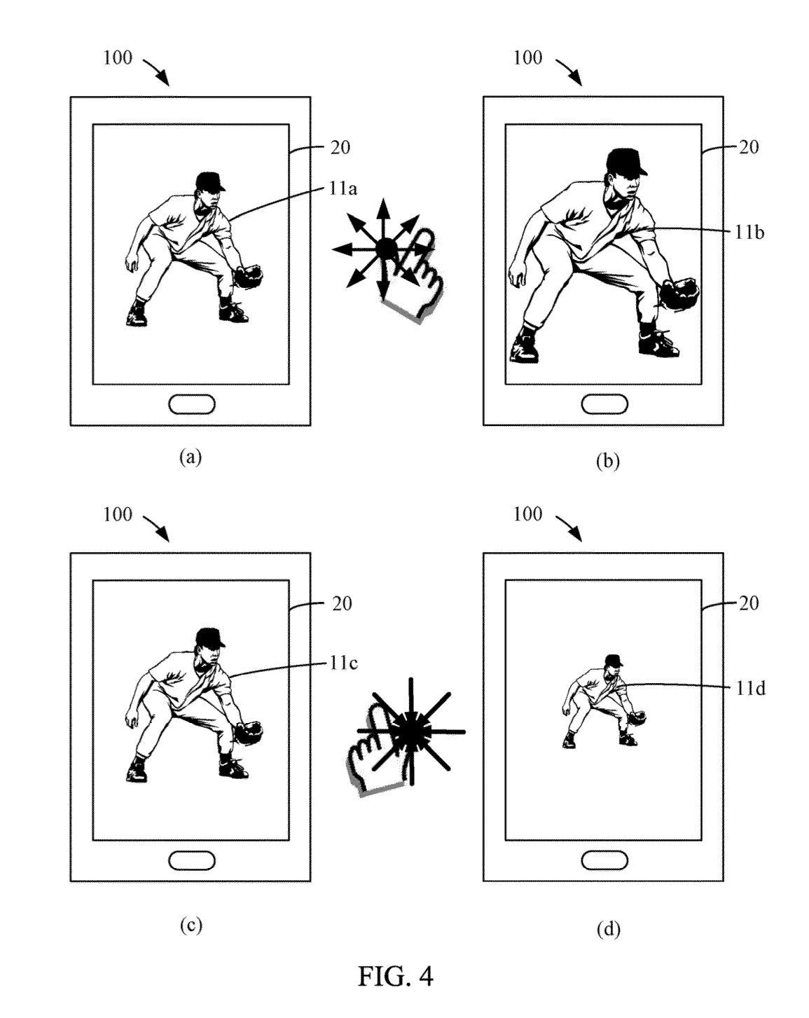

In a third embodiment, when the gesture identification module 31 identifies that one finger of the user creates a touch point on the touch screen 20, another finger slides away from the touch point on the touch screen 20, the gesture identification module 31 determines the touch operation is a zooming in gesture. When the gesture identification module 31 identifies that one finger of the user creates a touch point on the touch screen 20, another finger slides towards the touch point on the touch screen 20, the gesture identification module 31 determines the touch operation is a zooming out gesture. The details will be illustrated with reference to FIG. 4 later.

In a fourth embodiment, when the gesture identification module 31 identifies that one finger of the user creates a touch point on the touch screen 20, another finger slides away form the touch point on the touch screen 20, the gesture identification module 31 determines the touch operation is a zooming out gesture. When the gesture identification module 31 identifies that one finger of the user creates a touch point on the touch screen 20, another finger slides towards the touch point on the touch screen 20, the gesture identification module 31 determines the touch operation is a zooming in gesture.

The storage unit 10 further stores a relationship table including the mapping relationship between a number of slide distance and a number of zooming ratios.

The page zooming module 32 determines the slide distance of the slide operation according to the operation signals transmitted from the touch screen 20, determines a zooming ratio according to the slide distance value and the relationship table stored in the storage unit 10. Then creates a zoomed page according to the gestures results identified by the gesture identification module 31 and the determined zooming ratio. In this embodiment, the zooming ratio is directly proportional to the slide distance of the slide operation. For example, if the slide distance of the slide operation is 50 millimeters, the corresponding zooming ratio is 10%, if the slide distance of the slide operation is 100 millimeters, the corresponding zooming ratio is 20%. If the slide distance of the slide operation is 300 millimeters, the corresponding zooming ratio is 60%, for example.

If the gesture identification module 31 identifies the touch operation is a zooming in gesture, the page zooming module 32 creates a zoomed page which is zoomed in with the determined zooming ratio relative to the current page displayed on the touch screen 20. If the gesture identification module 31 identifies the touch operation is a zooming out gesture, the page zooming module 32 creates a zoomed page which is zoomed out with the determined zooming ratio relative to the current page displayed on the touch screen 20.

The display control module 33 controls to display the zoomed page created by the page zooming module 32 on the touch screen 20.

FIG. 3 illustrates several schematic diagrams of the user interface of the electronic device 100 showing the zooming effect and the zooming gestures applied on the touch screen 20, in accordance to an embodiment. The details are illustrated as follows.

FIG. 3(a) shows the current page 11a is displayed on the touch screen 20. If the user applies a zooming operation on the page 11a, the page 11a will be zoomed by the electronic device 100. Fox example, if one finger of the user creates a touch point on the page 11a, another finger of the user slides clockwise on the page 11a, the touch screen 20 generates operation signals in response to the touch operation. The gesture identification module 31 identifies the touch operation is a zooming in gesture. The page zooming module 32 determines the slide distance of the slide operation according to the operation signals, determines a zooming ratio according to the slide distance value and the relationship table stored in the storage unit 10, and creates a zoomed page 11b. The display control module 33 controls to display the zoomed page 11b on the touch screen 20 (see FIG. 3(b)).

Then, if one finger of the user creates a touch point on the page 11b, another finger of the user slides counterclockwise on the page 11b. Then, the gesture identification module 31 identifies the touch operation is a zooming out gesture. The page zooming module 32 creates a zoomed page 11c accordingly. Then, as is shown in FIG. 3(c), the touch screen 20 displays the zoomed page 11c. In this embodiment, the values of the trace length of the slide operations on the page 11a and the page 11b are the same, thus, page 11a and page 11c have a same display size.

Then, if one finger of the user creates a touch point on the page 11c, another finger of the user slides counterclockwise on the page 11c. Then, the gesture identification module 31 identifies the touch operation is a zooming out gesture. The page zooming module 32 creates a zoomed page 11d accordingly. Then, as is shown in FIG. 3(d), the touch screen 20 displays the zoomed page 11d.

FIG. 4 illustrates several schematic diagrams of the user interface of the electronic device 100 showing the zooming effect and the zooming gestures applied on the touch screen 20, in accordance to another embodiment. The difference between this embodiment and the embodiment illustrated with reference to FIG. 3 is: the slide operation in this embodiment is sliding away from the touch point or sliding towards the touch point. The details are illustrated as follows.

FIG. 4(a) shows the current page 11a is displayed on the touch screen 20. Then, if one finger of the user creates a touch point on the page 11a, another finger of the user slides away from the touch point in any direction on the page 11a, the gesture identification module 31 identifies the touch operation is a zooming in gesture. The page zooming module 32 creates a zoomed page 11b accordingly. Then, as is shown in FIG. 4(b), the touch screen 20 displays the zoomed page 11b. Then, if one finger touches on one point of the page 11b, another finger slides towards the touch point in any direction on the page 11b with a same slide distance to the slide distance of the slide operation on the page 11a, as is shown in FIG. 4(c). After that the touch screen 20 displays the zoomed page 11c having a same size as the page 11a.

Then, if one finger of the user creates a touch point of the page 11c, another finger of the user slides towards the touch point in any direction on the page 11c, as is shown in FIG. 4(d), then the touch screen 20 displays the zoomed out page 11d.

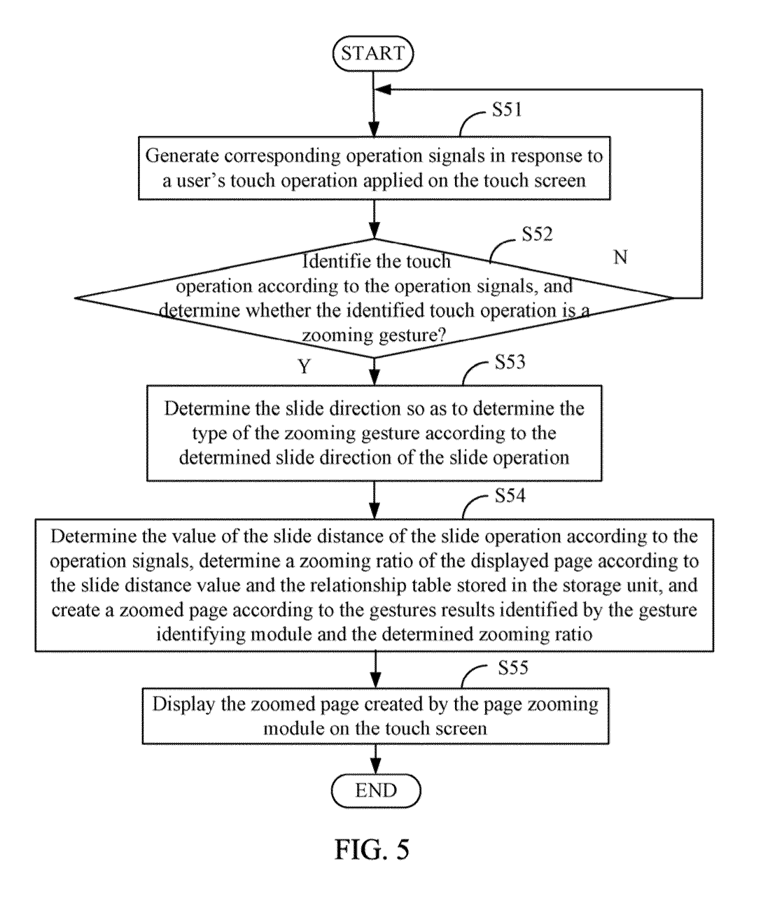

FIG. 5 shows a flowchart of a page zooming method of the electronic device 100 of FIG. 1. The electronic device 100 includes a touch screen and a storage unit. The touch screen is configured for generating operation signals in response to touch operations. The storage unit stores a relationship table including mapping relationship between a number of slide distance and a number of zooming ratios. The method includes the following steps, each of which is related to the various components contained in the electronic device 100.

In step S51, the touch screen 20 generates corresponding operation signals in response to a user's touch operation applied on the touch screen 20.

In step S52, the gesture identification module 31 identifies the touch operation according to the operation signals generated by the touch screen 20, and determines whether the identified touch operation is a zooming gesture. If yes, the process goes to step S53, otherwise, the process goes back to step S51. In this embodiment, when the gesture identification module 31 identifies a press operation and a slide operation immediately subsequent to the press operation applied on the touch screen 20, the gesture identification module 31 determines the identified touch operation is a zooming gesture.

In step S53, the gesture identification module 31 determines the slide direction so as to determine the type of the zooming gesture according to the determined slide direction of the slide operation. That is, the gesture identification module 31 determines whether the zooming gesture is a zooming in gesture or a zooming out gesture according to the determined slide direction of the slide operation. In an embodiment, when the gesture identification module 31 identifies that one finger of the user creates a touch point on the touch screen 20, another finger slides clockwise on the touch screen 20, the gesture identification module 31 determines the touch operation is determined as a zooming in gesture. When the gesture identification module 31 identifies that a touches point has been created on the touch screen 20, another finger slides counterclockwise on the touch screen 20, the gesture identification module 31 determines the touch operation is determined as a zooming out gesture.

In step S54, the page zooming module 32 determines the slide distance of the slide operation according to the operation signals, determines a zooming ratio of the displayed page according to the slide distance value and the relationship table stored in the storage unit 10, and creates a zoomed page according to the gesture results identified by the gesture identification module 31 and the determined zooming ratio. In this embodiment, the zooming ratio is directly proportional to the slide distance of the slide operation. The page zooming module 32 creates a zoomed page, which is zoomed with the determined zooming ratio relative to the current page displayed on the touch screen 20.

In step S55, the display control module 33 controls to display the zoomed page created by the page zooming module 32 on the touch screen 20.

With such a configuration, when the user wants to zoom the page displayed on the touch screen 20, the user uses one finger pressing on the page, and uses another finger sliding on the page, then, the page is zoomed and the zoomed page is displayed on the touch screen 20. The slide operation applied on the page can be sliding clockwise/counterclockwise, or sliding away/towards the touch point. The user can zoom in or zoom out the displayed page by controlling the slide direction of the sliding operation, and can dynamically control the zooming ratio by controlling the value of slide length.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. A page zooming method for an electronic device having a touch screen and a storage unit, the method comprising:
generating operation signals in response to a user' touch operation applied on a page displayed on the touch screen;
determining the touch operation as a zooming gesture if the touch operation comprising a press operation and a slide operation immediately subsequent to the press operation;
determining the slide direction of the slide operation so as to determine the type of the zooming gesture according to the determined slide direction of the slide operation, the type of the zooming gesture comprising a zooming in gesture and a zooming out gesture;
creating a zoomed page of the page displayed on the touch screen according to the type of the zooming gesture; and
displaying the zoomed page on the touch screen.

2. The method as described in claim 1, wherein the step “creating a zoomed page of the page displayed on the touch screen according to the type of the zooming gesture” comprises:
determining a slide distance of the slide operation according to the operation signals;
determining a zooming ratio of the displayed page according to the slide distance and a relationship table stored in the storage unit; and
creating and displaying the zoomed page according to the determined zooming ratio on the touch screen.

3. The method as described in claim 2, wherein the relationship table includes mapping relationship between the slide distance and the zooming ratios.

4. The method as described in claim 2, wherein the zooming ratio is directly proportional to the slide distance.

5. The method as described in claim 4, wherein the slide direction of the slide operation comprises sliding clockwise and sliding counterclockwise, if the slide operation is sliding clockwise, the type of the zooming gesture is determined as a zooming in gesture, and if the slide operation is sliding counterclockwise, the type of the zooming gesture is determined as a zooming out gesture.

6. The method as described in claim 4, wherein the slide direction of the slide operation comprises sliding away from the touch point of the press operation and sliding towards the touch point of the press operation, if the slide operation is sliding away from the touch point of the press operation, the type of the zooming gesture is determined as a zooming in gesture, and if the slide operation is sliding towards the touch point of the press operation, the type of the zooming gesture is determined as a zooming out gesture.

7. An electronic device, comprising:
a touch screen, configured for generating operation signals in response to a user's touch operation applied on a page displayed thereon;
a gesture identification module, configured for determining the touch operation as a zooming gesture if the touch operation comprises a press operation and an immediately subsequent slide operation, and determining the slide direction of the slide operation so as to determine the type of the zooming gesture according to the determined slide direction of the slide operation, the type of the zooming gesture comprising a zooming in gesture and a zooming out gesture;
a page zooming module, configured for creating a zoomed page of the page displayed on the touch screen according to the type of the zooming gesture; and
a display control module, configured for displaying the zoomed page on the touch screen.

8. The electronic device as described in claim 7, wherein the zooming ratio is directly proportional to the slide distance of the slide operation.

9. The electronic device as described in claim 7, wherein the electronic device further comprises a storage unit storing a relationship table, the page zooming module further determines the slide distance of the slide operation according to the operation signals, determines a zooming ratio according to the slide distance and a relationship table; and creates the zoomed page zoomed with the determined zooming ratio relative to the page displayed on the touch screen.

10. The electronic device as described in claim 9, wherein the relationship table includes mapping relationship between the slide distance and the zooming ratios.

11. The electronic device as described in claim 9, wherein the slide direction of the slide operation comprises sliding clockwise and sliding counterclockwise, if the slide direction of the slide operation is sliding clockwise, the type of the zooming gesture is a zooming in gesture, and if the slide direction of the slide operation is sliding counterclockwise, the type of the zooming gesture is determined as a zooming out gesture.

12. The electronic device as described in claim 9, wherein: the slide direction of the slide operation comprises sliding away from the touch point of the press operation and sliding towards the touch point of the press operation, if the slide direction of the slide operation is sliding away from the touch point of the press operation, the type of the zooming gesture is a zooming in gesture, and if the slide direction is sliding towards the touch point of the press operation, the type of the zooming gesture is determined as a zooming out gesture.
